(19) United States
(12) Patent Application Publication
(10) Pub. No.: US 2026/0057703 A1
(43) Pub. Date: Feb. 26, 2026

(54) Repetition Counting with Salient Frame Detection

(71) Applicant: Apple Inc., Cupertino, CA (US)

(72) Inventors: Xinke Deng, Santa Clara, CA (US); Stefano Alletto, Mountain View, CA (US); Abhishek Narain, San Ramon, CA (US); Yang Yang, Sunnyvale, CA (US); Jian Yao, Cupertino, CA (US); Joerg A Liebelt, Los Gatos, CA (US); Guodong Xu, Santa Clara, CA (US); Zhenlei Yan, Beijing (CN); Jinfeng Pan, Beijing (CN)

(21) Appl. No.: 19/307,443

(22) Filed: Aug. 22, 2025

Related U.S. Application Data
(60) Provisional application No. 63/685,946, filed on Aug. 22, 2024.

(51) Int. Cl. G06V 40/20; G06T 7/246; G06V 10/62; G06V 10/77; G06V 10/82; G06V 20/52

(52) U.S. Cl. CPC G06V 40/23; G06T 7/251; G06V 10/62; G06V 10/7715; G06V 10/82; G06V 20/52; G06T 2207/30196

(57) ABSTRACT

Determining characteristics of user motion is described. The technique includes capturing a series of frames of a user performing a motion and determining progress prediction and saliency scores for each of a set of candidate actions based on the features of the frames. The progress prediction score and saliency score are determined based on features of the current frame and one or more prior frames. The progress prediction value is determined and used to track repetitions of the user motion. Upon detecting the repetition has completed, salient frames are identified based on the saliency scores.

### BACKGROUND

Current techniques in image data analysis provide for numerous insights into a scene depicted in an image. For example, object detection can be used to identify objects in a scene, or characteristics of an object in a scene. One application is to apply image data to a network to determine a pose of a person.

Shortfalls exist when it comes to predicting motion of an object. For example, in order to predict an activity undertaken by a person, a video sequence of frames may be fed into a network, and a prediction for the video sequence may be obtained based on the entirety of the video. Problems exist in obtaining real-time predictions for a user activity.

### BRIEF DESCRIPTION OF THE DRAWINGS

FIG. 1 shows an example diagram of a technique for predicting a user activity, according to one or more embodiments.

FIG. 2 shows an example diagram for determining action, progress, and saliency scores, according to one or more embodiments.

FIG. 3 shows, in flowchart form, a technique for detecting salient frames and performing pose analysis, in accordance with one or more embodiments.

FIG. 4 shows, in flowchart form, a technique for performing a repetition count of detected motion classes, according to one or more embodiments.

FIG. 5 shows, in diagram form, a technique for determining action, progress, and saliency scores for multiple motion classes, according to one or more embodiments.

FIG. 6 shows, in flowchart form, a technique for using a determining action data using a common video encoder, according to one or more embodiments.

FIG. 7 shows, in diagram form, a technique for determining action, progress, and saliency scores for multiple motion classes, according to one or more embodiments.

FIG. 8 shows an example system diagram of an electronic device, according to one or more embodiments.

FIG. 9 shows, in block diagram form, a simplified multifunctional device according to one or more embodiments.

### DETAILED DESCRIPTION

This disclosure is directed to systems, methods, and computer readable media for exercise tracking and prediction. In general, techniques described herein are directed to capturing image data of the body of the motion and, in real time, predicting an activity being performed by a user. In addition, techniques described herein are directed to managing repetition count for the activity being performed, and identifying salient frames from the image data.

Embodiments described herein are directed to techniques for determining, on a per-frame basis, characteristics about a user motion captured in image data. In particular, action prediction values, progress prediction values, and saliency prediction values are determined for each of a set of candidate actions. In some embodiments, features may be extracted from each frame corresponding to a skeleton of the user. Generally, a network may be trained to ingest image data, determined body pose information, such as position and/or location information for various portions of the skeleton. Prediction information may be generated by the network, for example on a frame-by-frame basis, for each of the set of user activities. As a prediction information stabilizes over time, at least one of the set of activities can be identified of the activity being performed in the image data.

According to one or more embodiments, image data can be captured of a user performing an activity, such as an exercise. Although the activity may not be known to the system, the system can make a prediction as to which activities they performed while the activity is in progress. Generally, a network may be trained to ingest image data, determined body pose information, and based on body pose information, make the prediction as to an activity being performed. The network may be trained to predict the activity being performed based on a body pose in a current frame, as well as prior frames. Prediction information may be generated by the network, for example on a frame-by-frame basis, for each of the set of user activities.

The prediction information may include prediction scores. For example, the action prediction score for each of a set of candidate actions may indicate a likelihood that the current motion of the user belongs to the candidate action. The progress prediction score predicts, for each candidate action, how much of a single repetition of the activity is completed. The saliency score may indicate a likelihood, for each candidate action, that the frame includes a salient pose for the particular action, thereby classified as a salient frame. That is, a salient frame may be a frame of image data in which a relevant pose for the action is presented. Alternatively, the saliency score may indicate a progress measure toward a next salient frame for each candidate action.

Techniques described herein provide an improvement in user movement understanding by efficiently and accurately performing online activity detection and repetition tracking. In doing so, a user's motions can be classified and tracked in real time. In addition, the technique allows for salient frames to be identified based on body pose, and can be found anywhere in the process of the motion.

In the following description, for purposes of explanation, numerous specific details are set forth in order to provide a thorough understanding of the disclosed concepts. As part of this description, some of this disclosure's drawings represent structures and devices in block diagram form in order to avoid obscuring the novel aspects of the disclosed embodiments. In this context, it should be understood that references to numbered drawing elements without associated identifiers (e.g., 100) refer to all instances of the drawing element with identifiers (e.g., 100a and 100b). Further, as part of this description, some of this disclosure's drawings may be provided in the form of a flow diagram. The boxes in any particular flow diagram may be presented in a particular order. However, it should be understood that the particular flow of any flow diagram is used only to exemplify one embodiment. In other embodiments, any of the various components depicted in the flow diagram may be deleted, or the components may be performed in a different order, or even concurrently. In addition, other embodiments may include additional steps not depicted as part of the flow diagram. The language used in this disclosure has been principally selected for readability and instructional purposes and may not have been selected to delineate or circumscribe the disclosed subject matter. Reference in this disclosure to “one embodiment” or to “an embodiment” means that a particular feature, structure, or characteristic described in connection with the embodiment is included in at least one embodiment, and multiple references to “one embodiment” or to “an embodiment” should not be understood as necessarily all referring to the same embodiment or to different embodiments.

It should be appreciated that in the development of any actual implementation (as in any development project), numerous decisions must be made to achieve the developers' specific goals (e.g., compliance with system and business-related constraints), and that these goals will vary from one implementation to another. It will also be appreciated that such development efforts might be complex and time consuming but would nevertheless be a routine undertaking for those of ordinary skill in the art of image capture having the benefit of this disclosure.

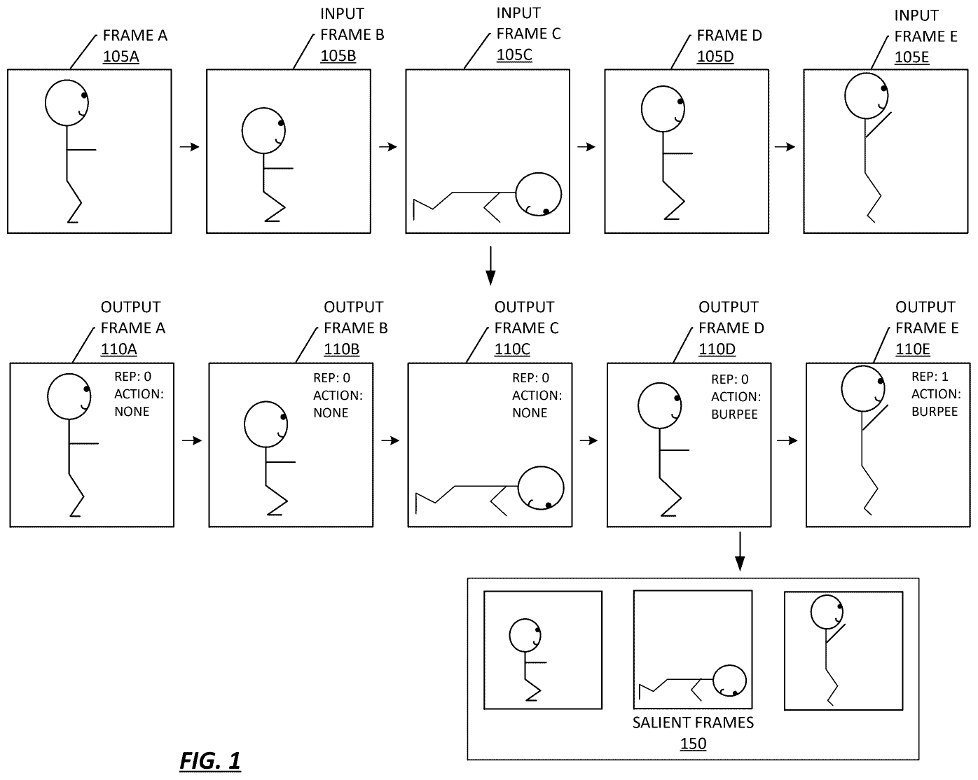

Referring to FIG. 1, a diagram is presented in which image data is processed to make the prediction as to the user activity being performed in the image data. In particular, the image data is captured in the form of input frames 105, which include input frame A 105A, input frame B 105B, input frame C 105C, input frame D 105D, and input frame E 105E. According to one or more embodiments, the input frames 105 may be captured by an electronic device. The electronic device may be any kind of device that includes a camera or other sensors from which pose information can be detected for a person in the invention. The electronic device capturing the image data may be the same or different from an electronic device performing the prediction of the activity.

In some embodiments, each image frame may be applied to a network to predict a body pose present in the image. Body pose may be predicted, for example, in the form of a 2D pose, a 3D pose, or the like. Body pose may include, for example, a classification of a pose, a representative skeleton for the pose, or the like. For example, the body pose of each of the input frames 105 may be determined based on an algorithm taking the image data and/or other sensor data of the user in motion, and predict a pose of the user, either in 2D or 3D. The pose may include, for example, a classification of a pose, a geometric representation of the pose, or the like. As an example, the pose may include a representation of joints and/or segments of a skeleton of a user.

The pose information may be used at each frame to determine prediction values related to the motion being performed. Prediction values may be determined for each of a set of candidate actions. Each prediction may be based on features of the current pose, and features from the poses of one or more prior frames. Prediction values may be used to determine, at each frame, a likelihood that the action being performed belongs to each of the set of candidate actions in the form of an action prediction score. The prediction values may also be used to predict how far through a single repetition of each candidate motion the user has performed in the form of a progress prediction score predicts. Finally, the predictions scores may include a saliency score indicating a likelihood, for each candidate action, that the frame includes a salient pose for the particular action.

According to one or more embodiments, the prediction scores may be used to drive data presented in output frames displayed, for example, on the electronic device. In some embodiments, the output frames 110 may be configured to provide information related to the user motion, such as a detected action, a repetition count, or the like. In particular, the activity data may be presented in output frames 110, which include output frame A 110A, output frame B 110B, output frame C 110C, output frame D 110D, and output frame E 110E.

According to one or more embodiments, input frame A 105A corresponds to output frame A. Input frame A 105A shows a user standing up. Thus, based on the pose, the system may not determine any particular action. Further, for purposes of the example, no repetitions have been completed, as reflected in output frame A 110A. At input frame 105B, the user is performing a squat. However, because a squat may be related to multiple actions, such as a squat or a burpee, the system may not reflect any detected activity in output frame 110B.

Turning to input frame 105C, the user is performing a pushup. Based on the fact that the pushup has followed the squat of input frame A 105B, the system may determine that the user is performing a burpee, but may not have sufficient confidence in the burpee, for example, if the user has just awkwardly entered a pushup action. The user then completes the burpee in input frame 105D, where the user is performing a slight knee bend, and input frame 105E, where the user is performing a jump. Accordingly, output frame D 110D reflects a detection action of “burpee.” In output frame 110E, because a burpee ends with a jump, the system may determine that the repetition is complete, and may increment a repetition count provided on the user interface.

According to one or more embodiments, the system may also use salient frame prediction values that each frame presents a salient pose for a particular action. A network may be trained to predict action-specific salient poses, which are identified based on a detected pose in the input frame. Each action may have a different number of salient poses. As an example, as shown in FIG. 1, salient frames 150 include input frame B 105B where the user is performing a squat, input frame C 105C, where the user is performing a pushup, and input frame E 105E, where the user is performing the jump. These frames, and/or data relate to the frames such as pose information, prediction values, and the like, may be stored and/or provided to a user for analyzing a quality level of the action, determining a correction for the action, or the like.

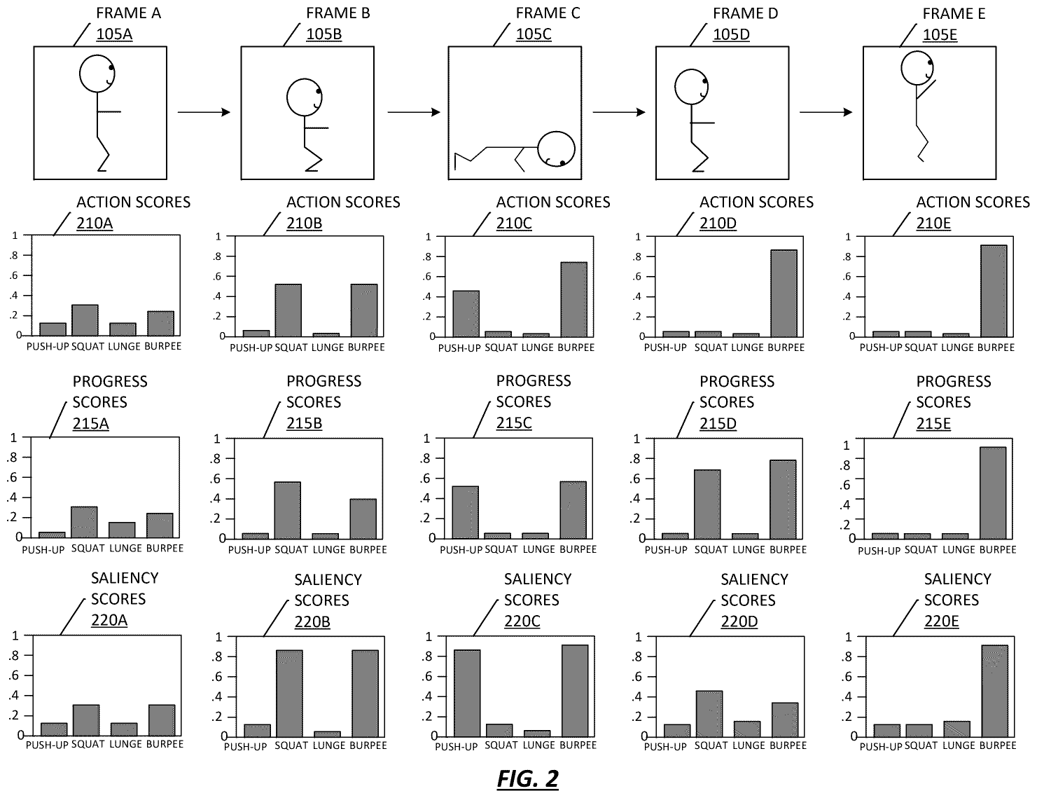

Turning to FIG. 2, four potential exercises are considered by the network. These include a squat, a lunge, a push-up, and a burpee. For each frame 105, action scores 210, progress scores 215, and saliency scores are determined. For example, action scores 210A depict a likelihood that the pose from frame a 105A belongs to each of the candidate actions. Thus, as shown, the system determines that the action is slightly more likely a squat or a burpee than a push up or a lunge. The action scores are determined on a peripheral basis, and are based on features of the pose in the current frame, along with features from one or more prior frames. Thus, frame B105B is associated with action scores 210B. Here, the action scores indicate that the action is very unlikely to be a push up or a lunge, and is somewhat likely to be a squat or a burpee. Turning to frame C105C, the pose is now in a push up position. Thus, the corresponding action score in 210C shows a strong likelihood of a burpee, but still somewhat of a likelihood of a push up. For example, it may be that the user got into a push up position in an awkward way. However, the current frame shows that the action is very unlikely to be a squat. At frame D 105D, the action scores 210D show a strong likelihood of a burpee, whereas the likelihood of the other actions has dropped. Accordingly, at frame D 105D, the system may determine that the action in a series of frames 105 is a burpee. In some embodiments, the difference between the action score for the burpee and a next highest action score may be sufficient to determine that the action is conclusively a burpee. Thus, returning to output frame D 110D, the action is now identified as a burpee. In FIG. 2, frame E 105E, the final pose is a jump. Thus, the action score 210E corresponding to frame E 105E depicts a strong likelihood of a burpee, and little likelihood of the other actions.

According to one or more embodiments, for each frame, a progress score is also predicted. Progress scores 215 may indicate a predicted percentage of a single repetition of the corresponding action that has been completed by that frame. For example, progress score A 215A depicts a likelihood that the pose from frame A 105A (a user with slightly bent legs both on the ground) is very early into a pushup or lunge. However, the progress scores 215A for a burpee and a squat are both higher. Notably, the progress score for the squat is higher than that of the burpee because, although both begin the same way, the squat is a shorter duration action than a burpee. Similarly, frame B105B is associated with progress scores 215B. Here, the progress scores 215B indicate that the progress scores for the squat and burpee continue to rise as both include a squat. By contrast, the pushup and lunge scores are both negligible, as the squat position in frame B 105B is not associated with either action. Turning to frame C 105C, the pose is now in a push up position. Thus, the corresponding progress scores 215C show that, if the action is a pushup, then the progress of the pushup is 0.5. Similarly, if the action is a burpee, the progress of the burpee is 0.5. However, the current pose is not part of a squat or lunge, so those progress scores 215C are negligible.

At frame D 105D, the pose shows bent legs coming out of a squat. Thus, the corresponding progress scores 215D show that, if the action is a squat, then the progress of the squat is 0.6, or nearing completion. Similarly, if the action is a burpee, the progress of the burpee is 0.8, which is slightly higher than the squat because the burpee action is a longer duration. However, the current pose is not part of a pushup or lunge, so those progress scores 215D are negligible. Finally, at frame E 105E, the progress scores 215E show that the burpee action has been completed. However, the network has determined that the pose is not part of a pushup, squat, or lunge, so those progress scores are negligible. Returning to FIG. 1, because the action score for the series of frames 105 has been identified as a burpee, and the progress score for the burpee indicates a repetition has been completed, then the repetition count is incremented, and a current count is updated at output frame 110E to show a repetition count of 1.

Returning to FIG. 2, a saliency score may be determined for each frame of the series of frames 105. The saliency score may indicate, for each candidate action, a likelihood that the pose in the frame is a salient pose for the action. For example, a network may be trained to detect different salient poses for various candidate actions. Accordingly, the salient poses are action specific. In addition, each candidate action may be associated with a different number of salient poses. The salient poses may be identified at any point during a repetition of the motion. Further, because the saliency is determined based on pose, and not necessarily the progress, salient poses are not limited to the beginning or end of a repetition, or a midpoint defined by the beginning and end.

For example, saliency scores A 220A depict a likelihood that the pose from frame A 105A (a user with slightly bent legs both on the ground) shows a likelihood that the pose is considered a salient pose for each of any push up, a squat, lunge, and a burpee. In the example, the slight bend of the knee is not associated with a high probability of being a salient pose for any of the candidate actions. However, the saliency score is slightly higher for squat and a burpee, as the slight leg bend is at least part of the action of the squat and the burpee. Turning to frame B105B, the pose is associated with saliency scores 220B. Here, the saliency scores 220B indicate that the squat pose in frame B 105B is more likely a salient pose for a squat and burpee than for a pushup and a lunge.

Turning to frame C 105C, the pose is now in a push up position. Thus, the corresponding saliency scores 220C show that, if the action is a pushup, then the saliency score is very high. Similarly, if the action is a burpee, the saliency score is very high, as both a pushup and a burpee include a pushup, and the frame shows a subject at the bottom of the pushup. However, the current pose is not part of a squat or lunge, so those saliency scores 220C are negligible.

At frame D 105D, the pose shows bent legs coming out of a squat. Thus, the corresponding saliency scores 220D show that, if the action is a squat or a burpee, then the saliency score is low. By contrast, if the action is a pushup or a lunge, those saliency scores 220D are negligible. Finally, at frame E 105E, the pose is part of a jump. Thus, the saliency score 220E is high for a burpee, but low for the other actions, as they do not include a jump.

According to one or more embodiments, the saliency scores can be used in combination with the action scores to determine salient frames for an action. For example, although frame B 105B shows a salient frame for a squat, and Frame C 105C shows a salient frame for a pushup, the action scores 210 indicate that the detected action is a burpee. Accordingly, the set of salient frames includes frame B 105B, frame C 105C, and frame E 105E based on the saliency scores for the burpee action. The salient frames may be identified by frames having a salient score above a predefined saliency threshold, based on peak saliency scores throughout the action, or the like. Returning to FIG. 1, because the action score for the series of frames 105 has been identified as a burpee, and the saliency scores for the burpee indicates that frames 105B, 105C, and 105E are salient frames, then those frames are stored or provided as salient frames 150.

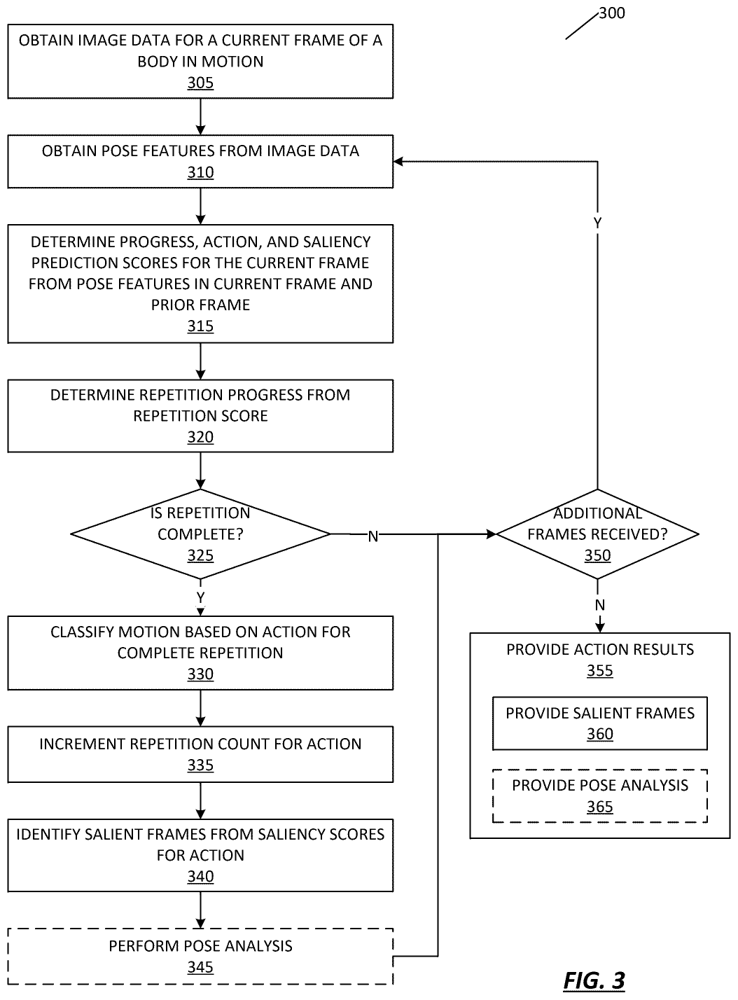

FIG. 3 shows, in flowchart form, a technique for detecting salient frames and performing pose analysis, in accordance with one or more embodiments. For purposes of explanation, the following steps will be described in the context of particular components. However, it should be understood that the various actions may be taken by alternate components. As an example, a single system may perform all the actions described with respect to FIG. 3. Alternatively, separate components may perform the functions and the functionality may be distributed across multiple systems or devices. In addition, the various actions may be performed in a different order. Further, some actions may be performed simultaneously, and some may not be required, or others may be added.

The flowchart 300 begins at block 305, where image data is obtained for a current frame of a body in motion. According to one or more embodiments, the body may be a user or other person in an environment for which image data and/or other sensor data is collected. According to one or more embodiments, the image data may be captured by an electronic device. Electronic device may be any kind of device that includes a camera or other sensors from which pose information can be detected for a person in the invention. The electronic device capturing the image data may be the same or different from an electronic device performing the prediction of the activity.

The flowchart 300 proceeds to block 310, where pose features are obtained from the image data. In some embodiments, body tracking is performed by an algorithm taking the image data and/or other sensor data of the user in motion, and predict a pose of the user, either in 2D or 3D. The pose prediction may include, for example, a type or classification of a particular pose, a geometric representation of the pose, or the like. As an example, the pose may include a representation of joints and/or segments of a skeleton of a user. According to one or more embodiments, spatial transformers may be used to extract features from a pose.

At block 315, action, progress, and saliency prediction scores are determined for the current frame from the pose features in the current frame and prior frames. The action, progress, and saliency scores may be determined from one or more networks or other modules configured to predict or provide classification information for the frames based on the pose features. In some embodiments, an action network may be trained to predict a likelihood score for a particular candidate action, such as a predefined motion, exercise, or the like. Alternatively, in some embodiments, a single network may be trained to predict action scores for multiple candidate actions. Similarly, a progress prediction network may be trained to predict how much of a repetition of a particular action has been completed at a given frame. Further, a saliency network may be trained to predict a saliency score for each frame for a particular candidate action, or a single network may be trained to predict saliency scores for multiple candidate actions. The saliency network(s) may be trained based on predefined poses for each candidate action, and each candidate action may be associated with a different number of saliency poses. In some embodiments, the action network, progress prediction network, and/or saliency network may be embodied in computational modules configured to provide the corresponding output based on the pose features in the current frame and prior frames. Based on the progress score, a determination of a repetition progress is made at block 320. This may include, for example, for one or more candidate action types, a prediction of how much of a single repetition has been completed. At block 325, a determination is made as to whether a repetition is complete. This may occur, for example, when one of the repetition scores for one of the candidate actions exceeds a threshold progress score. As another example, the determination may be based on a threshold high repetition score followed by a threshold low repetition score for a particular action, which may indicate that the action came to an end and is repeating. If at block 325, the repetition is determined to be complete, then the flowchart proceeds to block 330.

At block 330, the frames are classified based on the action for which the progress score triggered the determination that the repetition is complete. That is, the action for which the threshold was satisfied is used to classify the frames. Optionally, once the action is identified, then the action used for classification may be provided for presentation to the user, for example as part of an output frame. This may occur before or after the repetition is complete.

The flowchart 300 proceeds to block 335, where a repetition count is incremented for the action. In some embodiments, the repetition count may be stored, and/or may be presented to the user. In one example, a repetition score may be presented on a user interface, for example as part of an output frame and displayed with the determined action. The value for the repetition count may be incremented.

The flowchart 300 continues to block 340, where salient frames are identified for the completed repetition. In some embodiments, the salient frames may be identified based on the saliency scores for the frames belonging to the particular repetition and the classified action. Said another way, the saliency scores associated with the classified action are analyzed for the frames associated with the repetition of the classified action. In the example of FIG. 2, the classification at Frame D 105D may be a burpee. Then, the saliency scores for burpees for frames 105A, 105B, 105C, and 105D are analyzed to identify the salient frames. Thus, frame B 105B and frame C 105C may be identified as salient frames based on the high saliency score. Frame E105E would similarly be classified as a salient frame, due to the high saliency score once captured and identified as part of the burpee repetition. The frames associated with saliency scores for the classified action that satisfy a threshold may be identified as the salient frames. In some embodiments, the progress score may be used to identify the beginning and the end of a particular action. These frames may additionally or alternatively be considered salient frames.

Returning to FIG. 3, optionally, at block 345, pose analysis is performed. According to one or more embodiments, pose analysis may involve comparing the pose of the salient frame to a target pose for the salient frame. For example, the pose in the salient frame may be compared against a predefined salient frame to identify corrective actions or other parameters related to the difference between the two.

The flowchart continues to block 350, and a determination is made as to whether additional frames are received. Further, returning to block 325, if the no complete repetition is identified, then the flowchart 300 also proceeds to block 350. If the additional frames are received, then the flowchart 300 returns to block 310, and pose features are obtained from the additionally received image data. That is, the process proceeds in real time as new frames are captured.

Returning to block 350, if no additional frames are received, then the flowchart 300 concludes at block 355. At block 355, the results related to the action are provided related to the set of frames. In some embodiments, the action data may be performed as data for an interface from an output frame which can be presented to a user. According to some embodiments, providing the action results may include, at block 360, providing the salient frames for the action, such as the salient frames identified from each repetition. In some embodiments, the salient frames may be provided for display, and/or may be stored for later review by the user.

In addition, optionally at block 365, providing the action data may include providing the pose analysis. In some embodiments, the pose analysis may include data determined at block 345. Further, the pose analysis may be provided in the form of a user interface providing data regarding the pose of the user in the salient frames as compared to a target pose. Moreover, in some embodiments, the pose analysis may be provided in the form of raw or filtered pose data stored for analysis.

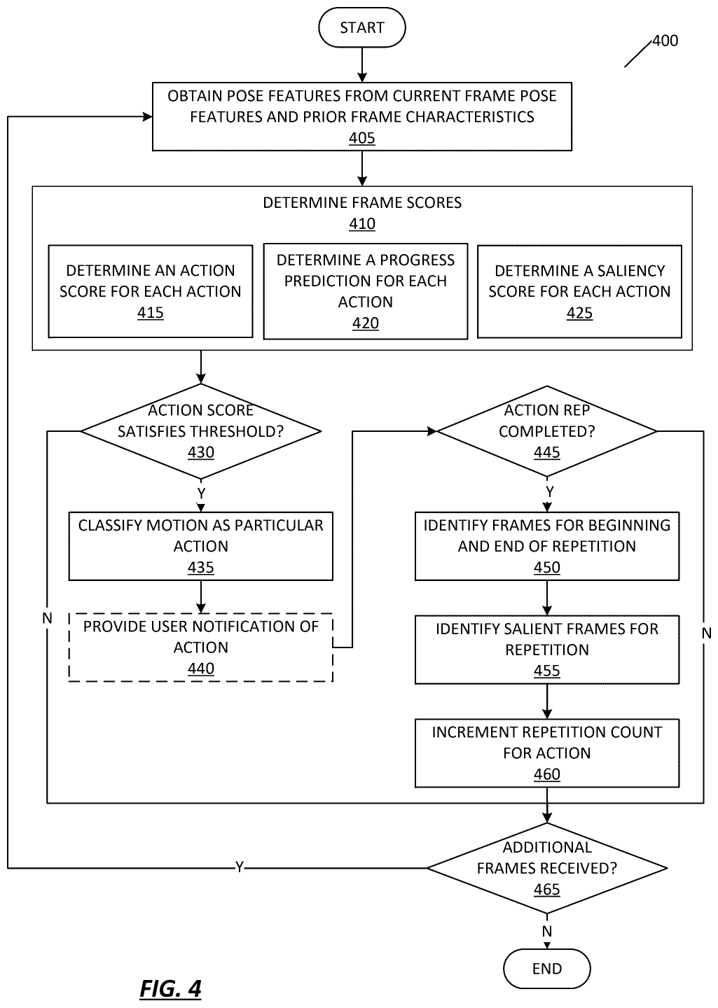

As described above, in some embodiments, the action scores, progress scores, and saliency scores may be determined concurrently during runtime. Accordingly, FIG. 4 shows, in flowchart form, a technique for performing a repetition count of detected motion classes, according to one or more embodiments. For purposes of explanation, the following steps will be described in the context of particular components. However, it should be understood that the various actions may be taken by alternate components. In addition, the various actions may be performed in a different order. Further, some actions may be performed simultaneously, and some may not be required, or others may be added.

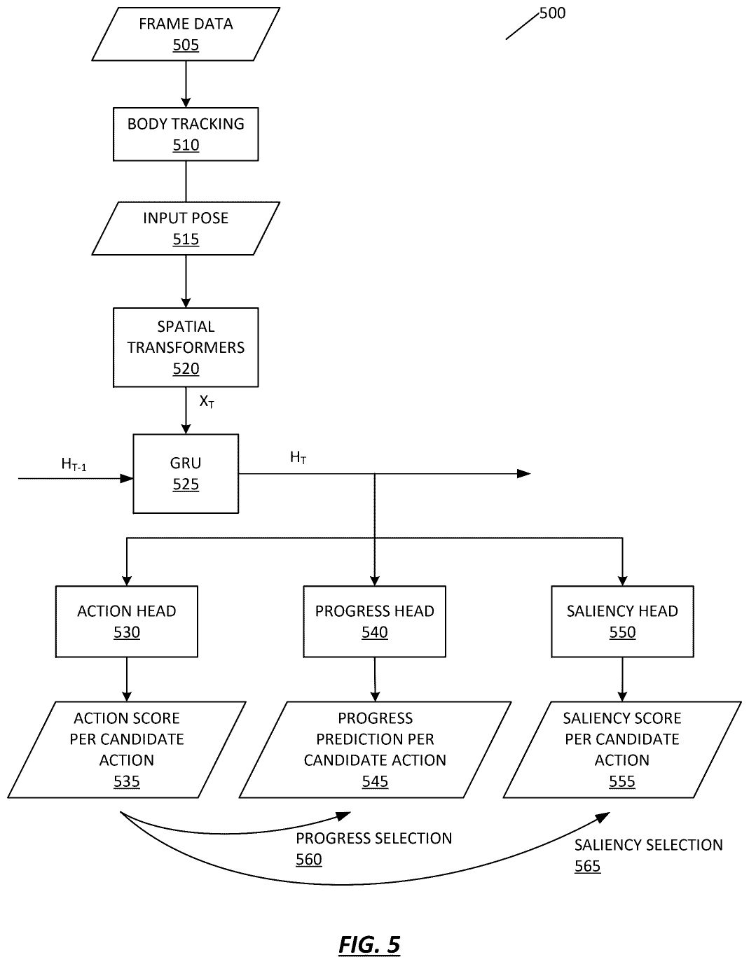

The flowchart 400 begins at block 405, where pose features are obtained from the current pose and prior frame characteristics. In some embodiments, body tracking is performed by an algorithm taking the image data and/or other sensor data of the user in motion, and predict a pose of the user, either in 2D or 3D. The pose features may include or indicate, for example, a classification of a pose, a geometric representation of the pose, or the like. As an example, the pose may include a representation of joints and/or segments of a skeleton of a user. In some embodiments, the pose features may be a representation of the pose detected by body tracking and provided in a manner which may be ingested by one or more models for predicting characteristics of an ongoing motion. In some embodiments, additional processing may be performed to incorporate features from one or more prior frames. For example, at least some of the features from the prior frame or frames may be concatenated or otherwise incorporated into the pose features. As another example, as will be described in greater detail below with respect to FIG. 5, a Gated Recurrent Unit (GRU) or other mechanism may be configured to augment the pose features from the current frame with a hidden state or other data from prior frames.

The flowchart 400 proceeds to block 410, where frame scores are determined. In one or more embodiments, multiple scores are determined for each frame. For example, at block 415, an action score is determined for each of a set of candidate actions. The action score may be determined by applying the pose features to an action network configured to predict a likelihood that the pose and the current frame corresponds to each of a set of candidate actions. For example, the action network may provide an action score with a percentage, or a value between zero to one, corresponding to a likelihood for each candidate actions of a set of candidate actions. Determining frame scores may also include, at block 420, a progress prediction score for each action of the candidate set of actions. The progress prediction score may be determined, for example, by applying the pose features to a progress network configured to predict how far a subject is into a single repetition based on the pose features. The progress prediction score may be represented in the form of a value from zero to one indicating a percentage of a single repetition of the corresponding action is predicted to be complete based on the pose features. Determining frame scores may also include, at block 425, a saliency score for each action of a set of candidate actions. As described above, one or more networks, such as the saliency network or other programmed module, may be configured to predict a likelihood that a given set of pose features corresponds to a salient pose for each of a set of candidate actions. Accordingly, a saliency score is determined for each candidate action and indicates a likelihood that the current frame presents a salient pose. In some embodiments, the saliency network may be trained based on predefined poses for each candidate action, and each candidate action may be associated with a different number of salient poses.

The flowchart 400 proceeds to block 430, where a determination is made as to whether an action score satisfies a threshold. According to some embodiments, the threshold may be a predefined action score which, when exceeded, indicates that the associated action corresponds to the set of frames. As another example, the threshold may be a threshold difference between the likelihood of a most likely action of the set of candidate actions in a second most likely action of the set of candidate actions based on the corresponding action scores. If a determination is made at block 430 that the action score does not satisfy a threshold, then the flowchart 400 proceeds to block 465 and a determination is made as to whether additional frames are received. Alternatively, if a determination is made at block 430 that the action score for a particular action satisfies the threshold, the flowchart 400 proceeds to block 435. At block 435, the motion is classified as the particular action. That is, the candidate action having the action score determined to satisfy the threshold is determined to be the current action being performed by the user motion. In some embodiments, once the motion is classified as a particular action, then a user notification of the action may be provided, as shown at optional block 440. For example, a user interface may be updated, or an audio or visual cue may be provided indicating the recognized action.

The flowchart 400 proceeds to block 445 where a determination is made as to whether a repetition of the action is completed, for example from the progress predictions for the particular action from block 420. According to one or more embodiments, the repetition is determined to be complete based on the progress prediction values for the particular action. For example, if the progress prediction value approaches or reaches a maximum value, such as 1, and then drops to a minimum or near minimum value, such as 0, then the system may detect that a repetition has been completed for the particular action. If the repetition is determined to not be completed, then the flowchart proceeds to block 465 determination is made as to whether additional frames are received.

If at block 445, the repetition is completed for the particular action, then the flowchart proceeds to block 450. At block 450, frames that begin and end the repetition are identified. According to some embodiments, the frames at the beginning and end of the repetition may be determined based on the progress prediction scores for the frames. At block 455, salient frames are identified for the particular action. In some embodiments, salient frames may be determined based on saliency scores for the set of frames between the frames identified as the beginning and end of the repetition, and based on the saliency score for the particular action for those frames, for example as determined at block 425. In some embodiments, the salient frames may be determined based on local maximum saliency scores within the repetition. As another example, salient frames may be determined based on a threshold saliency score. In some embodiments, the technique for determining the salient frames may be specific to a particular action. For example, different actions may have different numbers of salient poses. The technique for identifying salient frames may thereby involve determining a number of salient frames corresponding to the salient poses.

The flowchart 400 proceeds to block 460, and a repetition count is incremented for the particular action. If the repetition count is being presented to a user, for example in the form of a user interface overlay, then the data presented in the overlay may be updated to reflect the incremented repetition count. The flowchart 400 then proceeds to block 465. A determination may be made as to whether any additional frames are received, and if so, the flowchart returns to block 405. At block 405, pose features are obtained from which the processes described in blocks 410 through 465 can be applied.

FIG. 5 shows, in flow diagram form, a technique for determining action, progress, and saliency scores for multiple motion classes, according to one or more embodiments. The flow diagram depicts one particular technique which may be used for action prediction and salient frame identification.

The flow diagram 500 begins by collecting frame data 505. In some embodiments, the image data may be 2D or 3D image data capturing a subject performing a motion. The frame data 505 may be applied to a body tracking component 510. In some embodiments, body tracking is performed by an algorithm taking the frame data 505, and predicting a pose of the subject in the frames, either in 2D or 3D. The pose may include, for example, a classification of a pose, a geometric representation of the pose, or the like. As an example, the pose may include a representation of joints and/or segments of a skeleton of a user. In some embodiments, the pose features may be a representation of the pose detected by body tracking and provided in a manner which may be ingested by one or more models for predicting characteristics of an ongoing motion, for example as input pose 515. In some embodiments, the input pose 515 is applied to spatial transformers 520 to extract pose features (X_{T}). The pose features may be extracted on a per-frame basis.

According to one or more embodiments, a Gated Recurrent Unit (GRU) 525 may be configured to fuse the current features (X_{T}) with the past hidden state (H_{T-1}) to obtain a current hidden state (H_{T}). The current hidden state may therefore be derived from pose features from the current frame and pose features from one or more prior frames.

The hidden state may then be passed into three separate networks. The networks may be in the form of various types of neural networks. In one example, the networks may each be in the form of a multiplayer perceptron (MLP). The hidden states may therefore be applied to an action head 530, a progress head 540, and a saliency head 550. The action head may be configured to predict a likelihood that the pose and the current frame corresponds to each of a set of candidate actions based on the current hidden state. Accordingly, the output of the action head 530 may be an action score per candidate action 535.

The progress head 540 may be a progress prediction score is determined for each action of the candidate set of actions. The progress prediction score may be determined, for example, by applying the hidden states to a progress head 540 configured to predict how far a subject is into a single repetition of each of a set of candidate actions. Accordingly, the output of the progress head 540 is a progress prediction per candidate action 545.

The saliency head 550 may be configured to predict saliency scores for a given frame, for each action of the set of candidate actions. In particular, the saliency head 550 may be configured to predict a likelihood that the current frame contains a salient pose for each of the set of candidate actions. Alternatively, the saliency head 550 may be configured to predict a progress toward a next salient pose based on the pose features of the current frame. Accordingly, the output of saliency head 550 is a saliency score per candidate action 555.

According to one or more embodiments, the action score is used to predict a current action being performed. Upon determining a current action being performed based on the action score per candidate action 535, the current action may be used to select the relevant progress score for the frame by progress selection 560, for example based on the progress score corresponding to the same current action. Similarly, the current action may be used to select the relevant saliency score for the frame by saliency selection 565, for example based on the saliency score corresponding to the same current action.

According to some embodiment, a unified video encoder may be used to generate video features from input image data to determine different predictions, such as the action, progress, and/or salient frames. The unified video encoder may be specially trained to generate a set of consolidated features that satisfy multiple uses downstream. For example, the unified video encoder may be trained to generate a feature set that can be used to make predictions related to the action, progress, and/or salient frames, such that the prediction data can be determined in parallel and without relying on dependencies between models, thereby introducing resilience among the different prediction heads.

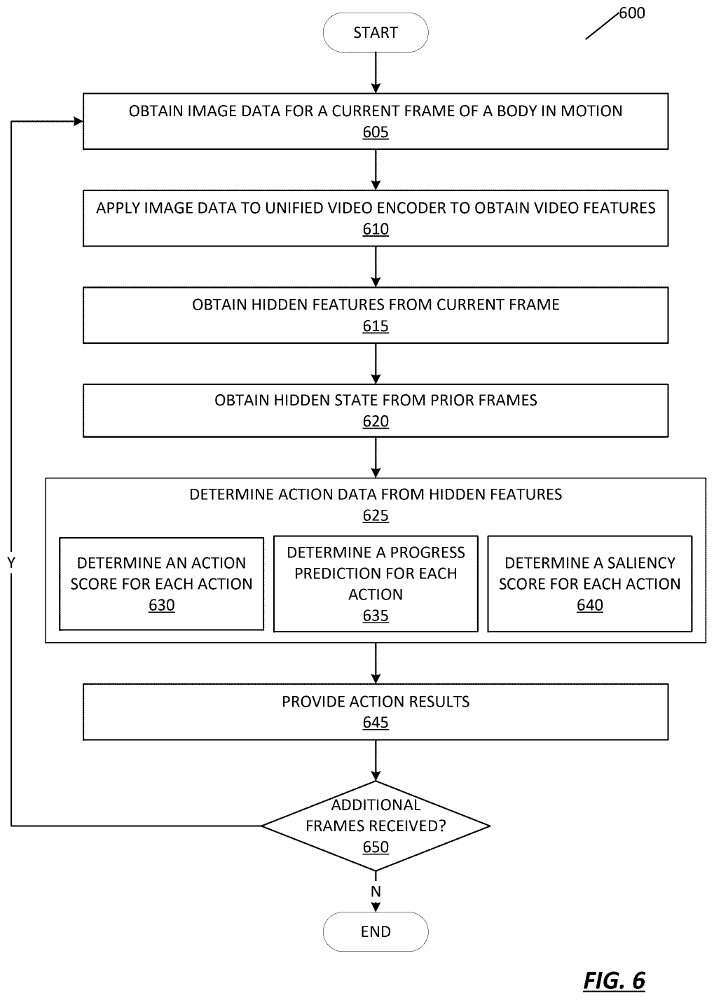

FIG. 6 shows, in flowchart form, a technique for predicting action data using a unified video encoder, according to one or more embodiments. For purposes of explanation, the following steps will be described in the context of particular components. However, it should be understood that the various actions may be taken by alternate components. In addition, the various actions may be performed in a different order. Further, some actions may be performed simultaneously, and some may not be required, or others may be added.

The flowchart 600 begins at block 605, where image data is obtained for a current frame of a body in motion. According to one or more embodiments, the body may be a user or other person in an environment for which image data and/or other sensor data is collected. According to one or more embodiments, the image data may be captured by an electronic device. Electronic device may be any kind of device that includes a camera or other sensors from which pose information can be detected for a person in the invention. The electronic device capturing the image data may be the same or different from an electronic device performing the prediction of the activity.

At block 610, the image data is applied to a unified video encoder, which is configured to obtain video features. The unified video encoder may be pre-trained using a combination of techniques to generate features which may be used for diverse functionality downstream. For example, the unified video encoder may be trained using a combination of sparse and dense input information, such that the resulting feature set can be used for predictions reliant on sparse understanding, and dense understanding. In some embodiments, the unified video encoder processes streaming video in real time, tokenizing each frame and passing the tokens through multiple transformer layers to extract rich, context-aware features.

The flowchart proceeds to block 615, where the video features are adjusted based on features from prior frames. For example, historic features from a prior frame may be combined with features from a current frame to generated adjusted features. As will be described below, a Gated Recurrent Unit (GRU) may be configured to fuse the current features with a hidden state from past frames to obtain adjusted features for the frame.

At block 620, action data is determined from the adjusted video features. In one or more embodiments, multiple scores are determined for each frame. In one or more embodiments, multiple scores are determined for each frame. Because the adjusted features are generated for handling multiple predictions, the various predictions can be performed in parallel or simultaneously, according to one or more embodiments. For example, at block 625, an action score is determined for each of a set of candidate actions. The action score may be determined by applying the adjusted video features to an action network configured to predict a likelihood that a user is performing one or more poses in the current frame. For example, the action network may provide an action score with a percentage, or a value between zero to one, corresponding to a likelihood for each candidate actions of a set of candidate actions. In some embodiments, the action data may also include a progress score for the particular frame. Determining action data may also include, at block 630, a progress prediction score for each action of the candidate set of actions. The progress prediction score may be determined, for example, by applying the adjusted video features to a progress network configured to predict how far a subject is into a single repetition. The progress prediction score may be represented in the form of a value from zero to one indicating a percentage of a single repetition of the corresponding action is predicted to be complete based on the pose features. Determining the action data may also include, at block 635, a saliency score for each action of a set of candidate actions. As described above, one or more networks, such as the saliency network or other programmed module, may be configured to predict a likelihood that a given set of adjusted video features corresponds to a frame including a salient pose for each of a set of candidate actions.

The flowchart proceeds to block 640, where the results of the action data are provided. In some embodiments, the action data may be provided as data for an interface from an output frame which can be presented to a user. According to some embodiments, providing the action results may include providing the salient frames for the action, such as the salient frames identified from each repetition. In some embodiments, the salient frames may be provided for display, and/or may be stored for later review by the user. Further, the action data may be provided to a client application which may use the action data for further processing. A determination is made at block 645 as to whether any additional frames are received. If no additional frames are received, then the flowchart concludes. If additional frames are received, then the flowchart returns to block 605 and the next frames are processed.

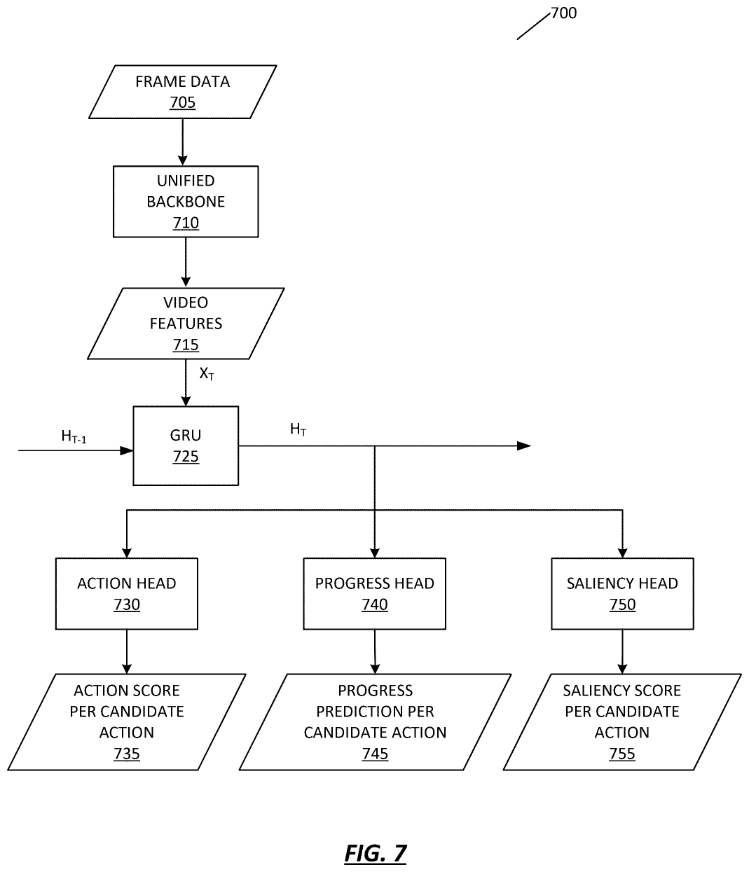

FIG. 7 shows, in flow diagram form, an example technique for determining action, progress, and saliency scores for multiple motion classes, according to one or more embodiments. The flow diagram depicts one particular technique which may be used for action prediction and salient frame identification, for example as described above with respect to FIG. 6.

The flow diagram 700 begins by collecting frame data 705. In some embodiments, the frame data may include image frames capturing a subject performing a motion. The frame data 705 may be applied to a unified video encoder 710. The unified video encoder 710 may be a self-supervised, vision-transformer-based encoder that has been pre-trained using pixel-level view-invariant objectives and global cross-modal alignment objectives. The encoder may therefore provide dense, semantically rich token embeddings in the form of video features 715 that maintain contextual information from the frame, as well as geometric tasks, such as 3D pose data. The video features may be extracted on a per-frame basis, shown as (X_{T}).

According to one or more embodiments, a Gated Recurrent Unit (GRU) 725 may be configured to fuse the current features (X_{T}) with the past hidden state (H_{T-1}) to obtain a current hidden state (H_{T}). The current hidden state may therefore be derived from video features from the current frame (X_{T}) and video features from one or more prior frames.

The hidden state (H_{T}) may then be passed into multiple networks or models, such as neural networks. In one example, the networks may each be in the form of a multiplayer perceptron (MLP). The hidden state may therefore be applied to an action head 730, a progress head 740, and a saliency head 750. The action head may be configured to predict a likelihood that the pose and the current frame corresponds to each of a set of candidate actions based on the current hidden state. Accordingly, the output of the action head 530 may be an action score per candidate action 735.

The progress head 740 may be a progress prediction score is determined for each action of the candidate set of actions. The progress prediction score may be determined, for example, by applying the hidden states to a progress head 740 configured to predict how far a subject is into a single repetition of each of a set of candidate actions. Accordingly, the output of the progress head 740 is a progress prediction per candidate action 745.

The saliency head 750 may be configured to predict saliency scores for a given frame, for each action of the set of candidate actions. In particular, the saliency head 750 may be configured to predict a likelihood that the current frame contains a salient pose for each of the set of candidate actions. Alternatively, the saliency head 750 may be configured to predict a progress toward a next salient pose based on the pose features of the current frame. Accordingly, the output of saliency head 550 is a saliency score per candidate action 755.

Because all three estimations arise from a common set of features, predictions for each of the action, progress, and saliency can be determined without reliance on each other. Thus, if any particular prediction fails, valid prediction data may be obtained for other models.

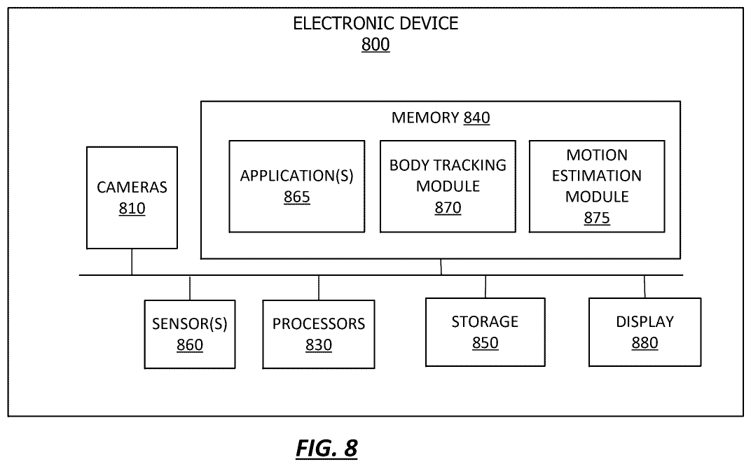

Referring to FIG. 8, a simplified block diagram of an electronic device 800 is depicted, in accordance with one or more embodiments of the disclosure. Electronic device 800 may be part of a multifunctional device, such as a mobile phone, tablet computer, personal digital assistant, portable music/video player, wearable device, or any other electronic device that includes a camera system. FIG. 8 shows, in block diagram form, an overall view of a system diagram capable of supporting proximity detection and breakthrough, according to one or more embodiments. Electronic device 800 may be connected to other network devices across a network via network interface, such as mobile devices, tablet devices, desktop devices, as well as network storage devices such as servers and the like. In some embodiments, electronic device 800 may communicably connect to other electronic devices via local networks to share sensor data and other information.

Electronic Device 800 may include one or more processors 830, such as a central processing unit (CPU). Processor 830 may be a system-on-chip such as those found in mobile devices and include one or more dedicated graphics processing units (GPUs). Further, processor 830 may include multiple processors of the same or different type. Electronic Device 800 may also include a memory 840. Memory 840 may include one or more different types of memory, which may be used for performing device functions in conjunction with processor 830. For example, memory 840 may include cache, ROM, and/or RAM. Memory 840 may store various programming modules during execution, including applications module 865, body tracking module 870, and motion estimation module 875. According to some embodiments, application(s) 865 may provide a user with activity-based tracking and feedback. As an example, application(s) may include health applications, exercise applications, or other applications where predicting and tracking user activity is utilized. Body tracking module 870 may utilize data from camera(s) 810 and/or sensor(s) 860, such as proximity sensors, to collect sensor data of a person performing a motion or activity, from which body pose can be derived. For example, body tracking module 870 may utilize a body tracking pipeline to predict a skeleton or other representation of a body in image data. Motion estimation module may utilize a network trained to generate predictions for characteristics of outcomes of one or more activities based on a current pose and prior pose information. For example, motion estimation module 875 may include functionality for utilizing the body tracking data to predict a current activity being performed among a set of candidate activities, a current progress of a duration of the set of candidate activities, and a prediction of salient frames for each of the candidate activities. The electronic device may include one or more storage devices 850, which may be used to hold data to facilitate processing of application(s) 865, body tracking module 870, and/or motion estimation module 875.

Electronic device 800 may include one or more cameras 810. The camera(s) 810 may each include an image sensor, a lens stack, and other components that may be used to capture images. In one or more embodiments, the cameras may be directed in different directions in the electronic device. For example, a front-facing camera may be positioned in or on a first surface of the electronic device 800, while the back-facing camera may be positioned in or on a second surface of the electronic device 800. In some embodiments, camera(s) 810 may include one or more types of cameras, such as RGB cameras, depth cameras, and the like. Electronic device 800 may include one or more sensor(s) 860 which may be used to detect physical obstructions in an environment. Examples of the senor(s) 860 include LIDAR and the like.

In one or more embodiments, the electronic device 800 may also include a display 880. Display 880 may be any kind of display device, such as an LCD (liquid crystal display), LED (light-emitting diode) display, OLED (organic light-emitting diode) display, or the like. In addition, display 880 could be a semi-opaque display, such as a heads-up display, pass-through display, or the like. Display 880 may present content in association with application(s) 865.

Although electronic device 800 is depicted as comprising the numerous components described above, in one or more embodiments, the various components may be distributed across multiple devices. Further, additional components may be used and/or some combination of the functionality of any of the components may be combined.

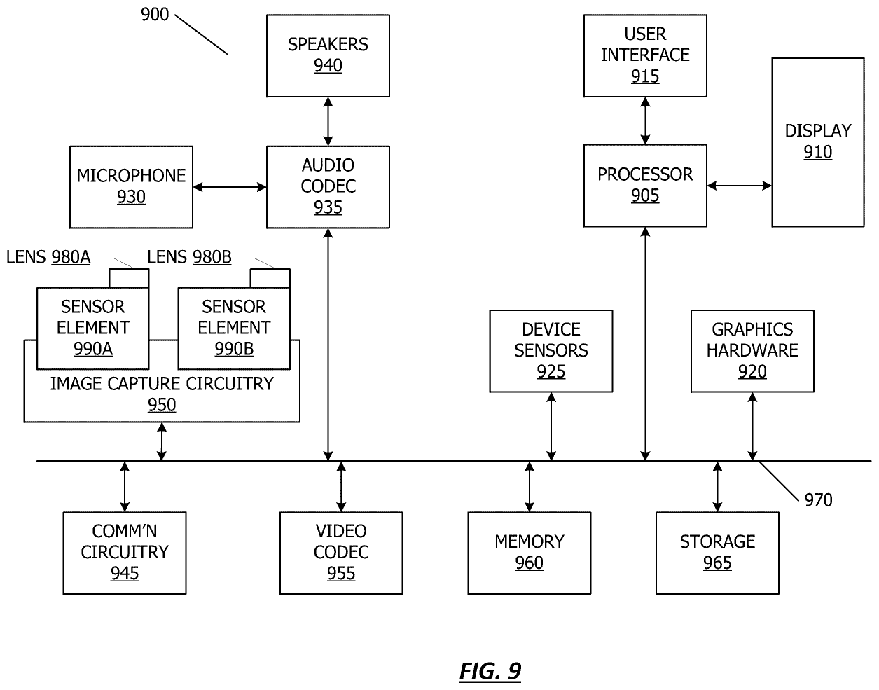

Referring now to FIG. 9, a simplified functional block diagram of illustrative multifunction device 900 is shown according to one embodiment. Multifunction electronic device 900 may include processor 905, display 910, user interface 915, graphics hardware 920, sensors 925 (e.g., proximity sensor/ambient light sensor, accelerometer and/or gyroscope), microphone 930, audio codec(s) 935, speaker(s) 940, communications circuitry 945, digital image capture circuitry 950 (e.g., including camera system), video codec(s) 955 (e.g., in support of digital image capture unit), memory 960, storage device 965, and communications bus 970. Multifunction electronic device 900 may be, for example, a digital camera or a personal electronic device such as a personal media player, mobile telephone, head-mounted device, or a tablet computer.

Processor 905 may execute instructions necessary to carry out or control the operation of many functions performed by device 900 (e.g., the generation and/or processing of images as disclosed herein). Processor 905 may, for instance, drive display 910 and receive user input from user interface 915. User interface 915 may allow a user to interact with device 900. For example, user interface 915 can take a variety of forms, such as a button, keypad, dial, a click wheel, keyboard, display screen and/or a touch screen. Processor 905 may also, for example, be a system-on-chip such as those found in mobile devices and include a dedicated graphics processing unit (GPU). Processor 905 may be based on reduced instruction-set computer (RISC) or complex instruction-set computer (CISC) architectures or any other suitable architecture and may include one or more processing cores. Graphics hardware 920 may be special purpose computational hardware for processing graphics and/or assisting processor 905 to process graphics information. In one embodiment, graphics hardware 920 may include a programmable GPU.

Image capture circuitry 950 may include two (or more) lens assemblies 980A and 980B, where each lens assembly may have a separate focal length. For example, lens assembly 980A may have a short focal length relative to the focal length of lens assembly 980B. Each lens assembly may have a separate associated sensor element 990A and associated sensor element 990B. Alternatively, two or more lens assemblies may share a common sensor element. Image capture circuitry 950 may capture still and/or video images. Output from image capture circuitry 950 may be processed, at least in part, by video codec(s) 955, and/or processor 905, and/or graphics hardware 920, and/or a dedicated image processing unit or pipeline incorporated within circuitry 950. Images so captured may be stored in memory 960 and/or storage 965.

Sensor and camera circuitry 950 may capture still and video images that may be processed in accordance with this disclosure, at least in part, by video codec(s) 955, and/or processor 905, and/or graphics hardware 920, and/or a dedicated image processing unit incorporated within circuitry 950. Images so captured may be stored in memory 960 and/or storage 965. Memory 960 may include one or more different types of media used by processor 905 and graphics hardware 920 to perform device functions. For example, memory 960 may include memory cache, read-only memory (ROM), and/or random access memory (RAM). Storage 965 may store media (e.g., audio, image, and video files), computer program instructions or software, preference information, device profile information, and any other suitable data. Storage 965 may include one more non-transitory computer-readable storage mediums including, for example, magnetic disks (fixed, floppy, and removable) and tape, optical media such as CD-ROMs and digital video disks (DVDs), and semiconductor memory devices such as Electrically Programmable Read-Only Memory (EPROM), and Electrically Erasable Programmable Read-Only Memory (EEPROM). Memory 960 and storage 965 may be used to tangibly retain computer program instructions or code organized into one or more modules and written in any desired computer programming language. When executed by, for example, processor 905, such computer program code may implement one or more of the methods described herein.

The scope of the disclosed subject matter should be determined with reference to the appended claims, along with the full scope of equivalents to which such claims are entitled. In the appended claims, the terms “including” and “in which” are used as the plain-English equivalents of the respective terms “comprising” and “wherein.”

1. A method comprising:
capturing a series of frames of a user performing a motion, the series of frames comprising a first frame, a second frame, and a third frame, wherein the second frame is captured between the first frame and third frame;
determining, for the second frame, a first progress prediction score and a first saliency score based on features of the first frame and features of the second frame; and
in response to determining that the first progress prediction score for a first candidate action satisfies a repetition completion criterion:
determining a set of frames for a repetition,
detecting one or more salient frames based on the saliency scores for the set of frames, and
determining, for the third frame, a second progress prediction score and a second saliency score based on features of the first frame and features of the second frame.

2. The method of claim 1, wherein the saliency scores indicate a likelihood that a current frame captures a salient pose for a particular candidate action.

3. The method of claim 2, wherein the first candidate action is one of a set of candidate actions, wherein the first candidate action is associated with a first number of salient frames per repetition, and wherein a second candidate action of the set of candidate actions is associated with a second number of salient frames per repetition different than the first number of salient frames.

4. The method of claim 1, further comprising:
determining a characteristic of the motion based a pose of the user in the second frame in accordance with the second frame being identified as a salient frame.

5. The method of claim 1, further comprising:
determining, based on features of the first frame and features of the second frame, an action prediction score associated with the first candidate action for the second frame.

6. The method of claim 1, further comprising:
in response to determining that the repetition of the motion is complete:
incrementing a repetition count, and
presenting a notification of the repetition count.

7. The method of claim 1, wherein determining the first action prediction score comprises:
applying the features of the second frame to a Gated Recurrent Unit to obtain input values for at least one selected from a group consisting of an action network, a progress network, and a saliency network.

8. A non-transitory computer readable medium comprising computer readable code executable by a processor to:
capture a series of frames of a user performing a motion, the series of frames comprising a first frame, a second frame, and a third frame, wherein the second frame is captured between the first frame and third frame;
determine, for the second frame, a first progress prediction score and a first saliency score based on features of the first frame and features of the second frame; and
in response to determining that the first progress prediction score for a first candidate action satisfies a repetition completion criterion:
determine a set of frames for a repetition,
detect one or more salient frames based on the saliency scores for the set of frames, and
determining, for the third frame, a second progress prediction score and a second saliency score based on features of the first frame and features of the second frame.

9. The non-transitory computer readable medium of claim 8, wherein the saliency scores indicate a likelihood that a current frame captures a salient pose for a particular candidate action.

10. The non-transitory computer readable medium of claim 9, wherein the first candidate action is one of a set of candidate actions, wherein the first candidate action is associated with a first number of salient frames per repetition, and wherein a second candidate action of the set of candidate actions is associated with a second number of salient frames per repetition different than the first number of salient frames.

11. The non-transitory computer readable medium of claim 10, further comprising computer readable code to:
determine a characteristic of the motion based a pose of the user in the second frame in accordance with the second frame being identified as a salient frame.

12. The non-transitory computer readable medium of claim 10, further comprising computer readable code to:
determine, based on features of the first frame and features of the second frame, an action prediction score associated with the first candidate action for the second frame.

13. The non-transitory computer readable medium of claim 10, further comprising computer readable code to, in response to determining that the repetition of the motion is complete:
increment a repetition count, and
present a notification of the repetition count.

14. The non-transitory computer readable medium of claim 13, wherein the computer readable code to determine the first action prediction score comprises computer readable code to:
apply the features of the second frame to a Gated Recurrent Unit to obtain input values for at least one selected from a group consisting of an action network, a progress network, and a saliency network.

15. A system comprising:
one or more processors; and
one or more computer readable media comprising computer readable code executable by the processor to:
capture a series of frames of a user performing a motion, the series of frames comprising a first frame, a second frame, and a third frame, wherein the second frame is captured between the first frame and third frame;
determine, for the second frame, a first progress prediction score and a first saliency score based on features of the first frame and features of the second frame; and
in response to determining that the first progress prediction score for a first candidate action satisfies a repetition completion criterion:
determine a set of frames for a repetition,
detect one or more salient frames based on the saliency scores for the set of frames, and
determining, for the third frame, a second progress prediction score and a second saliency score based on features of the first frame and features of the second frame.

16. The system of claim 15, wherein the saliency scores indicate a likelihood that a current frame captures a salient pose for a particular candidate action.

17. The system of claim 16, wherein the first candidate action is one of a set of candidate actions, wherein the first candidate action is associated with a first number of salient frames per repetition, and wherein a second candidate action of the set of candidate actions is associated with a second number of salient frames per repetition different than the first number of salient frames.

18. The system of claim 17, further comprising computer readable code to:
determine a characteristic of the motion based a pose of the user in the second frame in accordance with the second frame being identified as a salient frame.

19. The system of claim 17, further comprising computer readable code to:
determine, based on features of the first frame and features of the second frame, an action prediction score associated with the first candidate action for the second frame.

20. The system of claim 17, further comprising computer readable code to, in response to determining that the repetition of the motion is complete:
increment a repetition count, and
present a notification of the repetition count.
